(19) United States
(12) Patent Application Publication
(10) Pub. No.: US 2010/0203817 A1
(43) Pub. Date: Aug. 12, 2010

(54) MACHINE FOR ACCEPTING AND DISTRIBUTING COINS AND/OR TOKENS

(76) Inventor: Fabrizio Rigo, Borgonuovo di Sasso Marconi (IT)

Correspondence Address: LADAS & PARRY LLP, 224 SOUTH MICHIGAN AVENUE, SUITE 1600, CHICAGO, IL, 60604, US

(21) Appl. No.: 12/595,370

(22) PCT Filed: Jan. 14, 2008
(86) PCT No.: PCT/IB2008/000073

§ 371 Date: Apr. 23, 2010

(30) Foreign Application Priority Data
Apr. 11, 2007 (IT) BO2007A00260

(51) Int. Cl. G07D 9/00

(52) U.S. Cl. 453/3

(57) ABSTRACT

A machine (10) for accepting and distributing coins (M1, M2) comprising a housing (11) adapted in turn to contain: —an acceptance apparatus (12) of coins of a type (M1) paid in by a user; —a store (HP) of coins of type (M2); —a dispensing device (BC) of coins (M1, M2); —a pick-up device (20) adapted to pick up the coins of type (M2) from the store (HP) and send them to the dispensing device (BC); and—an electronic control board (CC) of the functions performed by the apparatus (12) and by the devices (HP, BC, 20). In the machine (10), the pick-up device (20), after having picked the coins up from the store (HP), sends the coins of type (M2) to the same acceptance apparatus (12) of the coins of type (M1).

### TECHNICAL FIELD

The present invention relates to a machine for accepting and distributing metallic coins and/or tokens. The machine is advantageously applied in coin and/or token dispensers and in so-called slot machines.

### BACKGROUND ART

As known, in automatic vendors, e.g. of beverages, and in slot machines, there are specific means for accepting metallic coins (e.g. means adapted to ascertain whether the metallic coins are authentic or counterfeit), and means for assigning a value to the incoming and exiting coins themselves.

Each coin inserted by the user passes through an acceptation device which may either return it to the user if its non-suitability is ascertained, or send it to a store (known as “hopper”).

From the store, each coin may be picked by a specific mechanism (see below) and sent outwards from the machine (e.g. for paying a winning, or for returning change), or may be possibly directed to a safe.

A machine of this type is described, for example, in patent application WO 2006/003212 (MONEY CONTROLS LIMITED).

This machine for accepting and distributing coins comprises a housing adapted in turn to contain:
an acceptance apparatus of coins of a first type paid in by a user;
a store of coins of a second type;
a dispensing device of the coins of the first and second type;
a pick-up device adapted to pick up the coins of the second type from the store and send them to the dispensing device; and
electronic control means of the functions performed by the apparatus and by the various devices.

However, this machine for accepting and distributing coins is cumbersome and not very convenient because it includes separate means for checking the pay-in coins and for checking the pay-out coins.

### DISCLOSURE OF INVENTION

Therefore, it is the object of the present invention to provide a machine for accepting and distributing coins, which is free from the above-described drawbacks and which is, at the same time, easy and cost-effective to make.

Therefore, according to the present invention, a machine for accepting and distributing coins according to the appended claims is made.

Incidentally, in the present description the word “coin” defines any essentially circular object having a certain monetary value. Therefore, the word “coin” also comprises the so-called “tokens”.

### BRIEF DESCRIPTION OF THE DRAWINGS

The present invention will now be described with reference to the accompanying drawings, which illustrate some non-limitative embodiments thereof, in which:

FIG. 1 shows a first three-dimensional overall view of a first embodiment of a machine for accepting and distributing coins according to the present invention;

FIG. 2 shows a partially sectioned front view of the machine in FIG. 1;

FIG. 3 shows some enlarged details of the machine shown in FIGS. 1 and 2;

FIG. 4 shows a three-dimensional overall view of a second embodiment of a machine for accepting and distributing coins according to the present invention;

FIG. 5 shows a front view of the machine in FIG. 4; and

FIG. 6 shows a block diagram of the machine shown in FIGS. 4, 5.

### BEST MODE FOR CARRYING OUT THE INVENTION

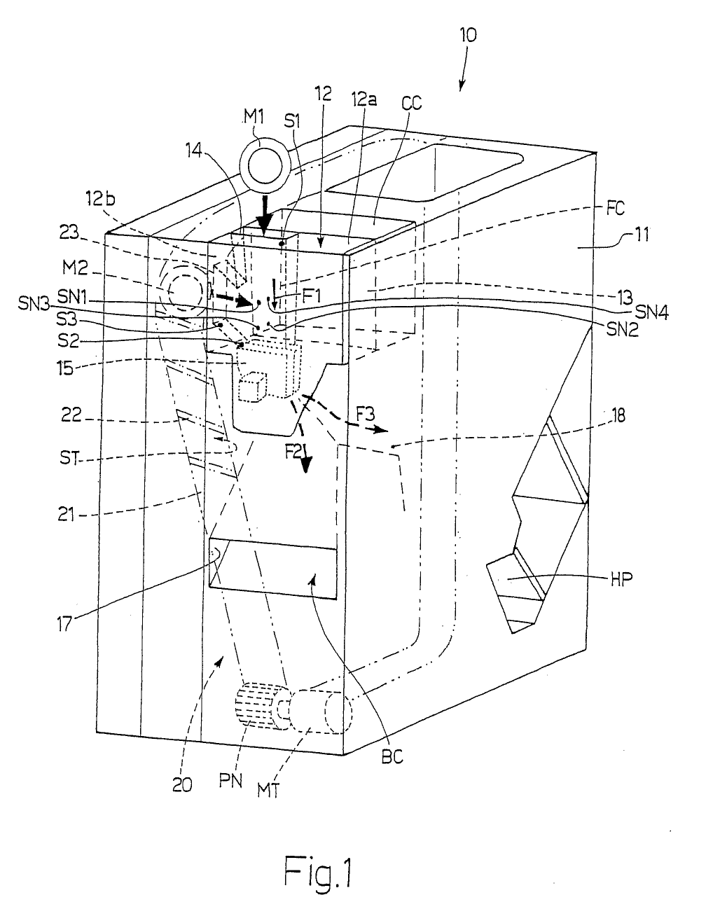

In FIG. 1, numeral 10 indicates as a whole a machine for accepting and distributing metallic coins according to the present invention.

The machine 10 includes an essentially parallelepiped box-shaped housing 11 adapted to contain an acceptance apparatus 12 of the coins M1 paid in by a user (not shown).

The acceptance apparatus 12 comprises, in turn, a main box-shaped body 13 provided, on an upper face 12a thereof, with an inlet slot 14 through which the coins M1 are inserted by a user into the machine 10 for effecting a payment or a stake.

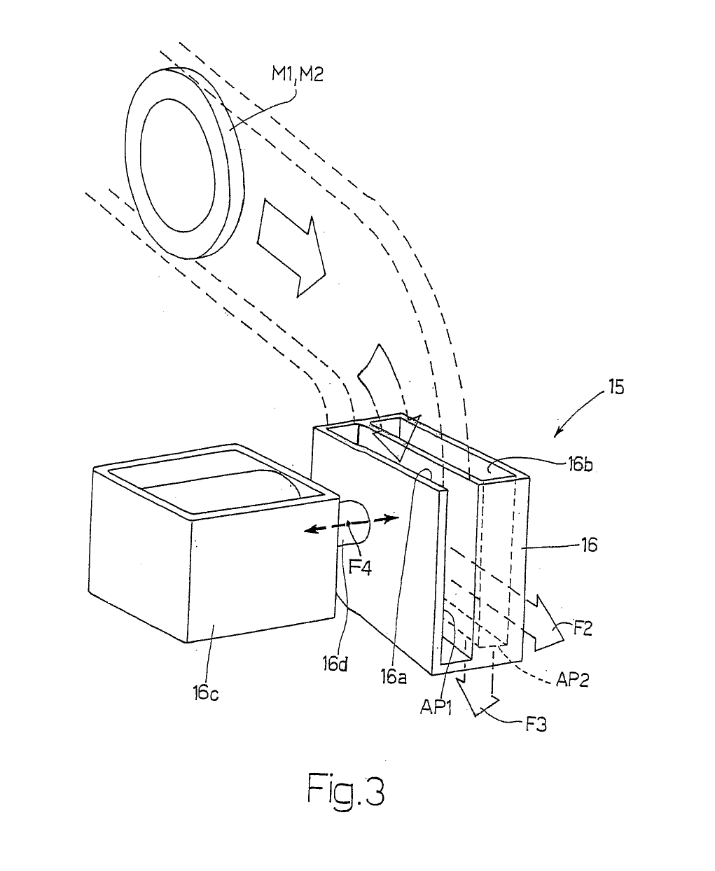

In the main box-shaped body 13, there is included a coin feeding and reading device FC further adapted to direct a generic incoming coin M1 through the inlet slot 14 towards a selector device 15, a possible embodiment of which will be described in greater detail below with reference to FIG. 3.

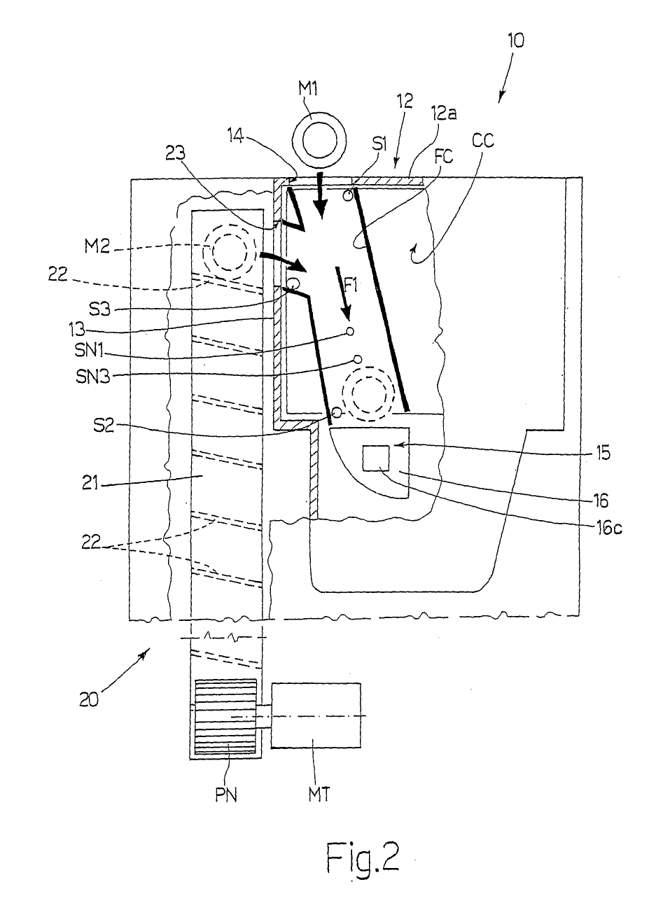

As shown in FIG. 2, a sensor S1 adapted to detect the transit of each coin M1 is arranged at the inlet slot 14.

Falling by gravity along a path defined by an arrow F1, the generic coin M1 is sent to the aforesaid selector device 15 passing firstly in front of four probes SN1, SN2, SN3, SN4 (FIG. 1) arranged in pairs on two opposite walls of the coin feeding and reading device FC.

In a known manner, the four probes SN1, SN2, SN3, SN4, detect the dimensions of the generic coin M1 transiting in the device FC and attribute a certain monetary value to it.

Furthermore, as shown in FIG. 2, before entering into the selector device 15, the generic coin M1 is detected by a sensor S2 which is also in the device FC.

The information about the generic incoming coin M1, read by the device FC, are sent with known electronic means to an electronic board CC embedded into the housing 11 and adjacent to the apparatus 12.

As shown in greater detail in FIG. 3, the selector device 15 comprises, in a known manner, a cashbox body 16 essentially consisting of two adjacent cashboxes 16a, 16b arranged side-by-side.

The cashbox 16a has a side opening AP1 from which the generic coin M1 is diverted according to an arrow F2, and the cashbox 16b includes a lower opening AP1 which addresses the generic coin M1 along a path defined by an arrow F3.

As shown in FIG. 1, when the coin M1 follows the path identified by the arrow F2, after exiting the pocket 16a through the opening AP1, it passes through a return channel 17. The coin M1 is thus returned to the user through a dispensing mouth BC (FIG. 1).

Similarly, when the coin M1 is accepted by the system, it enters into the pocket 16b following the path identified by the arrow F3 and enters into an acceptance channel 18 through which it is sent to a store HP.

In order to allow the selection of either the path defined by the arrow F2 or that identified by the arrow F3, the selector device 15 is provided with a solenoid 16c mechanically connected to the cashbox body 16 by means of a shaft 16d.

The solenoid 16c, controlled by electronic signals generated by the electronic board CC, acts on the cashbox body 16 displacing it in the two directions defined by a double pointed arrow F4.

It is furthermore worth noting that the arrow F4 is perpendicular to the arrow F1.

Therefore, if the system of sensors S1, S2 and of probes SN1, SN2, SN3, SN4 establishes that the coin M1 is not to be accepted by the machine 10 (because it is counterfeit, faulty, difficult to detect, etc.), the solenoid 16c, controlled by the signals from the board CC, places the cashbox 16a so that it corresponds exactly to the outlet of the device FC. In this first case, as mentioned, the coin M1 takes the path defined by the arrow F2.

Similarly, if the system of sensors S1, S2 and of probes SN1, SN2, SN3, SN4 accepts the coin M1, the solenoid 16c, again controlled by the signals from the board CC, places the cashbox 16b so that it is at the outlet of the device FC. Obviously, in this second case, the coin M1 is directed to the store HP along the path identified by the arrow F3.

It is apparent that FIG. 3 shows only one possible embodiment of the selector device 15. Other technical solutions may be therefore used for the same purpose, e.g. one (not shown) in which there is a plurality of solenoids in which each solenoid is associated to a corresponding butterfly selector valve.

The apparatus 10 further comprises a pick-up device 20 adapted to pick up the coins M1 from the store HP and send them as coins M2 to the acceptance apparatus 12.

It is worth specifying that the generic terms M1, M2 indicate two series of coins comprising coins with different monetary values. For example, both the series of coins M1 and the series of coins M2 may comprise 50 cent, [symbol] 1 and [symbol] 2 coins.

The pick-up device 20 is well known in the field and is described, for example, in patent application PCT WO 2006/003212 (MONEY CONTROLS LIMITED).

The pick-up device 20 comprises, in turn, a closed loop conveyor belt 21 wound about returns and pulleys (not shown).

The belt conveyor 21 is operated by a motor reducer MT1, the toothed pinion PN of which meshes with teeth (not shown in FIG. 1) included on the external surface of the belt conveyor 21 itself.

Additionally, on the inner surface of the belt conveyor 21, there is a plurality of seats ST arranged in step.

Each seat ST includes an inclined protruding element 22 adapted to support one coin M2 at a time.

The belt conveyor 21 is rotated when needed, i.e. when paying a winning or giving change is needed.

The motor reducer MT is also actuated by the electronic board CC, thus the rotation of the belt conveyor 21.

In another embodiment (not shown), a disc-shaped pick-up device of the type described, for example, in document EP-A2-1 647 943 is used instead of the pick-up device 20 using the belt conveyor 21.

In use, when the machine 10 needs to pay out through the dispensing mouth BC, the electronic control system actuates the motor reducer MT, which starts rotating the belt conveyor 21 which, in turn, starts randomly picking one coin M2 at a time from the pile inside the store HP at that time.

The coin M2 is inserted in a seat ST resting on the inclined protruding element 22.

Therefore, the generic coin M2 is taken by the belt conveyor 21 from the bottom of the machine 10 (i.e. from the store HP) to the upper part of the same where it slides by gravity on the inclined protruding element 22 into a slot 23 provided in a side wall 12b of the acceptance apparatus 12.

The coin M2 also slides into the device FC, which is the same path as the coins of the M1 type.

In other words, the generic coin M2 coming from the store HP enters into the same acceptance apparatus 12 where it is subjected to a presence check by a sensor S3 (FIG. 2) and to value assignment and quality controls by at least one portion of the same probes SN1, SN2, SN3, SN4 seen in the case of the generic coin M1 paid in at the machine 10.

Therefore, by using the same acceptance apparatus 12 for checking both M1 type coins (i.e. paid into the machine 10 by the user), and the M2 type coins (i.e. those which the machine 10 should pay out to the user), a considerable saving and simplicity of construction of the machine 10 itself is obtained.

Indeed, according to the present invention, there is no longer the need to perform difficult checks on the moving M2 type coins while they are being fed on the conveyor belt 21.

On the contrary, in the machine 10 object of the present invention, all the coins M2 which enter into the seats ST of the belt conveyor 21 are unloaded, none excluded, by the acceptance apparatus 12, where they are checked and selected as the M1 type coins are checked and selected.

In use, if the value of a certain coin M2 is not the one required, it is directed back to the store HP along the path defined by the arrow F3. In this case, the cashbox 16b is moved by the solenoid 16c and placed at the outlet of the device FC.

If in the contrary the value of the coin M2 is indeed the one required, the cashbox 16a is placed at the outlet of the device FC so as to allow the coin M2 itself to reach the dispensing mouth BC along the path defined by the arrow F2 and be dispensed to the user.

It is apparent that there may be more than two cashboxes in the cashbox body 16. Typically, there may be four cashboxes, whereby the third cashbox may be enabled to receive M1 or M2 type coins to be sent to a safe, and the fourth cashbox could be used to select coins, again of the M1 or M2 type, of a specific value to be sent to a container other than the container HP shown in FIG. 1.

For example, the machine 10 is assumed to pay out a [symbol] 40 winning to a user.

The machine 10 is further assumed to have already dispensed [symbol] 39. As previously mentioned, the dispensing of the coins M2 (in this case for a total of [symbol] 39) is performed by actuating the pick-up device 20 and the acceptance device 12.

At this point, [symbol] 1 remains to be paid to reach the total sum of [symbol] 40 of the winning.

A [symbol] 2 coin is assumed to have been randomly unloaded from the belt conveyor 21 into the slot 23. If the acceptance apparatus 12 made the [symbol] 2 coin pass according to the arrow F2, a sum exceeding the winning would be paid to the user; i.e. [symbol] 41 would be paid instead of the [symbol] 40 won.

For this reason, the [symbol] 2 coin M2 must be sent back to the store HP (along the path defined by the arrow F3). The system will now try again with the next M2 type coin, several times until either one [symbol] 1 coin or two 50 cent coins are selected (obviously one after the other, each contained in a corresponding seat ST).

In a further preferred embodiment (not shown in the accompanying figures), the electronic board is fully extractable from the top or from the side, being able to slide along appropriate guides (not shown).

In another preferred embodiment (not shown), the acceptance apparatus is extractable from the top or from the side being also able to slide along appropriate guides (not shown).

In a further embodiment (not shown), both the electronic board and the acceptance apparatus are slidingly extractable.

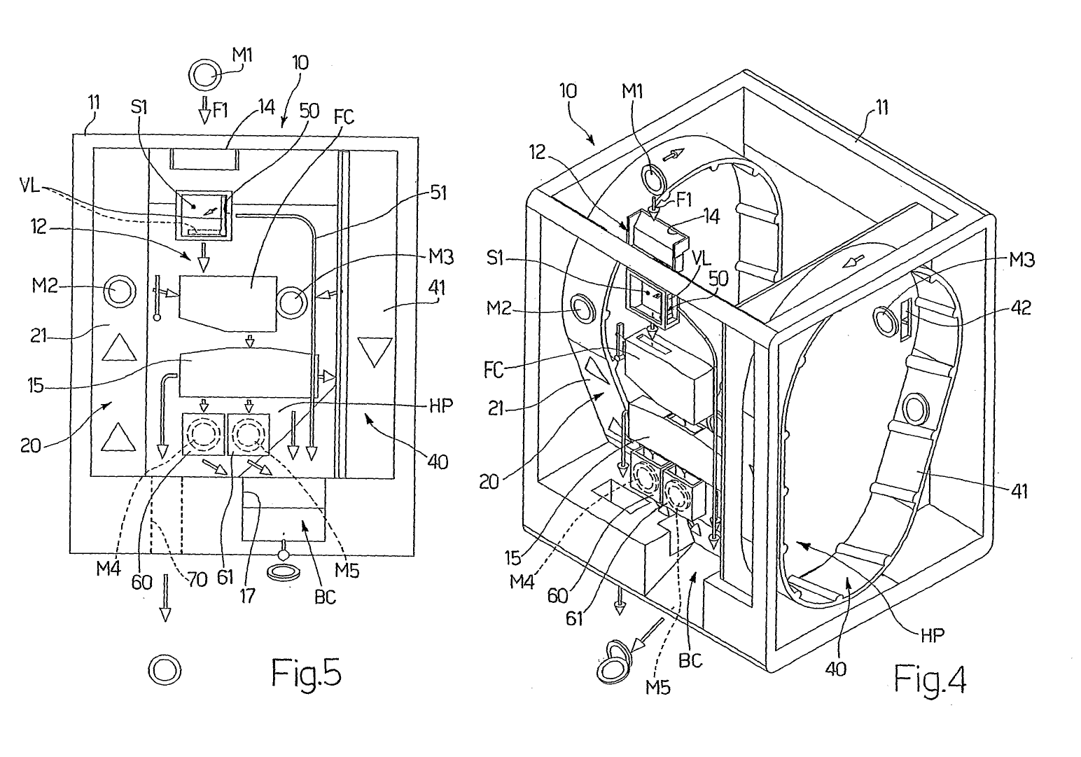

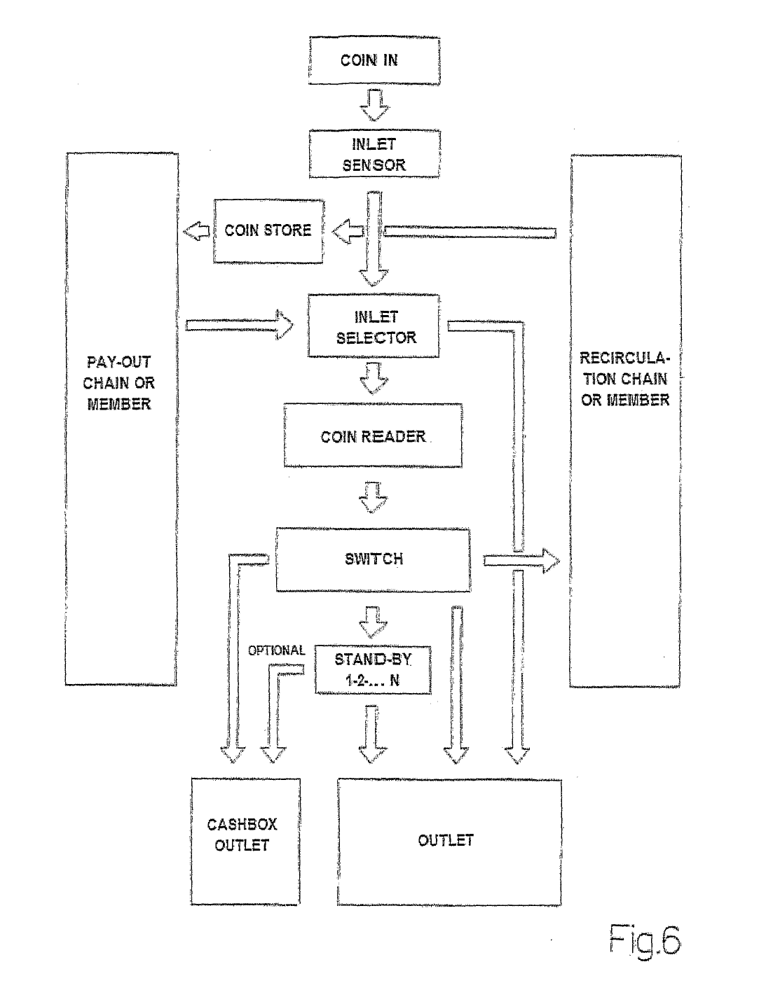

A further embodiment of the present invention is shown in FIGS. 4, 5.

In this second embodiment, the same reference numbers are used for devices either equivalent or similar to those shown with reference to first embodiment in FIGS. 1, 2, 3.

A fundamental feature of this second embodiment, which distinguishes it from the first embodiment, is given by the presence of a recirculation device 40 of the coins from the path defined by the arrow F3.

The recirculation device 40 comprises a belt conveyor 41 which is advantageously, but not necessary, rotated in a direction opposite to the belt conveyor 21 of the pick-up device 20.

Indeed, it has been experimentally observed that in the machine 10 illustrated in FIGS. 1, 2, 3, the coins which follow the path according to the arrow F3 tend to occupy the bottom of the store HP again, and thus it is established a phenomenon according to which the same coins tend to be repeatedly picked by the pick-up device 20.

In order to prevent this, it has been thought to use the recirculation device 40 of the coins M3 which, after having been lifted by the belt conveyor 41, cross a slot 42 and fall from the top onto the pile of coins M2 which are already stored in the store HP.

Therefore, statistically, the pick-up device 20 will always lift “new” coins M2 to be distributed.

Furthermore, the recirculation device 40, is essentially equal to the pick-up device 20 and therefore will not be described is greater detail.

In another embodiment (not shown), a disc-shaped pick-up device of the type described, for example, in document EP-A2-1 647 943 is used instead of the recirculation device 40 using the belt conveyor 41.

Specifically, the recirculation device 40 may include a motor reducer (not shown) in which the toothed pinion (not shown) meshes with teeth (not shown in FIG. 4) included on the outer surface of the belt conveyor 41.

In a further embodiment (not shown) the same motor reducer is used to move the belt conveyors 21 and 41 at the same time.

Furthermore, the second embodiment in FIG. 4 differs from the one in FIGS. 1, 2, 3 for the presence of a butterfly valve VL immediately after the sensor S1. If the pick-up device 20 is dispensing M2 type coins it is important not to count an M1 coin unintentionally inserted by the user. In such a case, the coin M1 accidentally inserted by the user in the inlet slot 14 is diverted to a slot 50 communicating with an ejection channel 51 of the coin M1 to the user through the dispensing mouth BC.

This avoids the mixing up of M2 type coins with M1 type coins.

Another particularity of the embodiment shown in FIGS. 4, 5 is that the selector device 15 may comprise a plurality of solenoids (not shown) associated to a corresponding plurality of butterfly valves (not shown) to send the coins toward N destinations.

Furthermore, in this second embodiment, the selector device 15 is also enabled to select the coins of a certain value (e.g. a 50 cent coin M4 and a [symbol] 1 coin M5), which, once selected, are conveyed to corresponding stand-by dispensers 60, 61.

In other words, for example, the stand-by dispenser 60 is adapted to contain a single coin M4 with a face value of 50 cents, while the stand-by dispenser 61 is adapted to contain a single coin M5 with a face value of [symbol] 1.

In general, it may be said that the values of coins M4 and MS may be either the same or different.

In a specific embodiment, one 50 cent coin M4 is always contained in the stand-by dispenser 60, and one [symbol] 1 coin M5 is always contained in the stand-by dispenser 61.

Therefore, the stand-by dispensers 60, 61 are fed by the system respectively with single 50 cent coins and, respectively, with single [symbol] 1 coins so that at least one 50 cent coin and at least one [symbol] 1 coin, respectively, are always ready to be paid.

Referring again to the previous payment example, assuming a pay-out of [symbol] 39 has been reached, the remaining [symbol] 1 may be paid by the stand-by dispenser 61 which, indeed, always accommodates one [symbol] 1 coin M5.

In this manner, having always available at least one 50 cent coin M4 and at least one [symbol] 1 coin M5, the dispensing of the coins queued to the pay-out which are needed to exactly balance the account are ready to be paid before the pay-out operations start. In this manner, the system does not need to waste time searching for the M2 type coins with the pick-up device 20 to complete the pay-out.

In other words, the stand-by dispensers 60, 61 may be considered as small stores each containing at least one coin of a certain type ready for the pay-out to prevent the pick-up device 20 from starting to search in the store HP the coins M2 of a certain value to settle the payment.

It must be said that the selector device 15 and the stand-by dispensers 60, 61 which are “downstream” thereof form a stand-by assembly which is not necessarily combined to a machine 10 of the type shown in FIGS. 4, 5, but may be installed on any machine for accepting and distributing coins and/or tokens, even already built.

In this manner, the stand-by assembly is configured as a proper “optional apparatus” which may be installed on any machine of this type.

Furthermore, through an outlet 70, the machine 10 automatically feeds a safe (not shown) transferring the M2 type coins from the store HP.

In order to better understand the operation of the machine 10 object of the present invention, reference may be made to FIG. 6 which illustrates a block diagram of the machine 10 itself.

The main advantages of the machine object of the present invention are due to the absence of control means of the coins transported by the belt conveyor, and to the absence of synchronized pushing means to make a certain coin pass from the belt conveyor to the dispensing mouth if it has the required value.

Furthermore, the machine is considerably simplified because there is no longer need for control and selection means of the pay-out coins separate from the control and selection means of the pay-in coins entered by user into the machine, but there are the same means to control and select both the pay-in and the pay-out coins.

1. A machine (10) for accepting and distributing coins (M1, M2) comprising a housing (11) adapted in turn to contain:
an acceptation apparatus (12) of coins of a first type (M1) paid in by a user; said acceptance apparatus (12) being provided with means (S1, S2, SN1, SN2, SN3, SN4, 15) adapted to identify and select said coins of a first type (M1);
a store (HP) of coins of a second type (M2);
a dispensing device (BC) of the coins of the first type (M1) and of the second type (M2);
a pick-up device (20) adapted to pick up the coins of the second type (M2) from the store (HP) and send them to said dispensing device (BC); and
electronic control means (CC) of the functions performed by said apparatus (12) and by said devices (HP, BC, 20); the machine (10) is characterized in that:
said pick-up device (20), after having picked the coins up from the store (HP), sends said coins of the second type (M2) to the acceptance apparatus (12) of the coins of the first type (M1).

2. A machine (10), as claimed in claim 1, wherein at least one portion of the same means (S1, S2, SN1, SN2, SN3, SN4, 15) is adapted to identify and select both the coins of the first type (M1), and the coins of the second type (M2).

3. A machine (10), as claimed in claim 1, wherein a first portion of the means (S1, S2, SN1, SN2, SN3, SN4, 15) is adapted to identify coins of type (M1), and a second portion of the means (S1, S2, SN1, SN2, SN3, SN4, 15) is adapted to identity coins of type (M2).

4. A machine (10), as claimed in claim 1, herein there is a single coin feeding and reading device (FC) for both the coins of the first type (M1) and the coins of the second type (M2).

5. A machine (10), as claimed in claim 1, wherein there is a single selection device (15) for both the coins of the first type (M1) and the coins of the second type (M2).

6. A machine (10), as claimed in claim 1, wherein the electronic control means comprise a single electronic board (CC).

7. A machine (10), as claimed in claim 6, wherein the electronic board (CC) is fully extractable, being able to slide along appropriate guides.

8. A machine (10), as claimed in claim 1, wherein the acceptance apparatus (12) is fully extractable, being able to slide along appropriate guides.

9. A machine (10), as claimed in claim 1, wherein it further comprises a recirculation device (40) of the coins from the path defined by the arrow (F3).

10. A machine (10), as claimed in claim 1, wherein a butterfly valve (VL) is provided immediately after a recognition sensor (S1) of the coins of type (M1) to prevent a coin (M1) unintentionally inserted into the machine (10) itself by a user while the pick-up device (20) is dispensing coins of type (M2) from being counted and returned to the user him or herself.

11. A machine (10), as claimed in claim 1, wherein said selector device (15) is used to select coins of a certain value, which, once selected, are sent to a corresponding stand-by dispenser (60, 61).

12. A machine (10), as claimed in claim 11, wherein the stand-by dispenser (60) is adapted to contain a single coin (M4) of a third type ready to be paid, while the stand-by dispenser (61) is adapted to contain a single coin (M5) of a fourth type ready for to be paid; the values of the coins (M4) and (M5) may be the same or different.

13. A stand-by assembly combinable to any machine (10) for accepting and distributing coins and/or tokens, even previously manufactured; the stand-by assembly wherein it comprises at least one selector device (21) and stand-by dispensers (60, 61) arranged “downstream” of such a selector device (21).

14. A stand-by assembly, as claimed in claim 13, wherein the stand-by dispenser (60) is adapted to contain a single coin (M4) ready to be paid, while the stand-by dispenser (61) is adapted to contain a single coin (M5) ready to be also paid; the values of the coins (M4) and (M5) may be the same or different.
